(19) United States
(12) Patent Application Publication
(10) Pub. No.: US 2002/0066191 A1
(43) Pub. Date: Jun. 6, 2002

(54) Light or laser indicator

(76) Inventor: Chao Fa Hsu, Taichung (TW)

Correspondence Address: Chao Fa HSU, P. O. Box 63-99, Taichung, 406, TW

(21) Appl. No.: 09/729,445

(22) Filed: Dec. 1, 2000

(51) Int. Cl. G01C 15/00

(52) U.S. Cl. 33/286; 33/276; 33/451; 33/DIG. 21

(57) ABSTRACT

An indicator has two radiation sources supported in a housing and directed to two perpendicular directions to generate two light beams and to indicate a right angle. A semi-transparent mirror is engaged in the housing, the light beam generated by one radiation source has a portion transmitted through the mirror and another portion reflected by the mirror to indicate another right angle, and to indicate two opposite points far spaced from each other. A cover has three windows aligned with the light beams for allowing the light beams to be transmitted out of said cover.

### BACKGROUND OF THE INVENTION

1. Field of the Invention

The present invention relates to an indicator, and more particularly to a light or laser indicator for indicating right angles or the like.

2. Description of the Prior Art

Typical light or laser indicators comprise a single electrical circuit connecting radiation source arranged for emitting a radiation beam along a plumb line or the like. U.S. Pat. No. 4,183,667 to Denton discloses one of the typical light indicators including a mirror for reflecting the radiation beam. Most of the typical light indicators may generate a single light or radiation beam only, and may not be used to indicate a right angle. The typical light indicators also may not be used to generate two lights or radiation beams to indicate two opposite points far spaced away from each other.

The present invention has arisen to mitigate and/or obviate the afore-described disadvantages of the conventional light or laser indicators.

### SUMMARY OF THE INVENTION

The primary objective of the present invention is to provide a light or laser indicator for indicating right angles or the like, and including one or more radiation sources and a semi-transparent mirror for indicating one or more right angles or for indicating two opposite points far spaced away from each other.

In accordance with one aspect of the invention, there is provided an indicator comprising a housing, a first radiation source and a second radiation source supported in the housing and directed to two directions perpendicular to each other, and means for energizing the first and the second radiation sources to generate two light beams and to indicate a right angle.

The housing includes an orifice and an aperture formed therein and spaced from each other and perpendicular to each other for receiving the first and the second radiation sources.

The housing includes two caps secured thereto to block the orifice and the aperture of the housing and to retain the the first and the second radiation sources in the housing.

The caps each includes a cavity formed therein, the housing further includes two lenses engaged in the cavities of the caps respectively, the light beams generated by the first and the second radiation sources are emitted through the lenses respectively.

The housing further includes two brackets secured to the caps and engaged with the lenses to secure the lenses to the caps respectively.

The housing includes a slot formed therein and intersecting and communicating with the orifice thereof, and a mirror is engaged in the slot of the housing. The mirror is a semi-transparent mirror, the light beam generated by the first radiation source includes a portion transmitted through the mirror and another portion reflected by the mirror.

The mirror is intersected with the light beam generated by the first radiation source with a 45° included angle, the light beams transmitted through the mirror and reflected by the mirror indicate another right angle. The light beam reflected by the mirror and the light beam generated by the second radiation source may be used to indicate two opposite points far spaced from each other.

The housing includes a bracket secured thereto and engaged with the mirror for securing the mirror to the housing. The bracket includes a hole formed therein and aligned with the light beam generated by the first radiation source for allowing the light beam generated by the first radiation source to transmit through the hole of the bracket.

A cover is further provided for receiving the housing, the cover includes two windows aligned with the light beams generated by the first and the second radiation sources for allowing the light beams to transmit through and out of the cover.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a light or laser indicator in accordance with the present invention;

FIG. 2 is a partial exploded view of the light or laser indicator in which the cover is separated from the base and the housing of the indicator; and

FIG. 3 is a partial exploded view of the light or laser indicator illustrating the elements of the housing of the indicator.

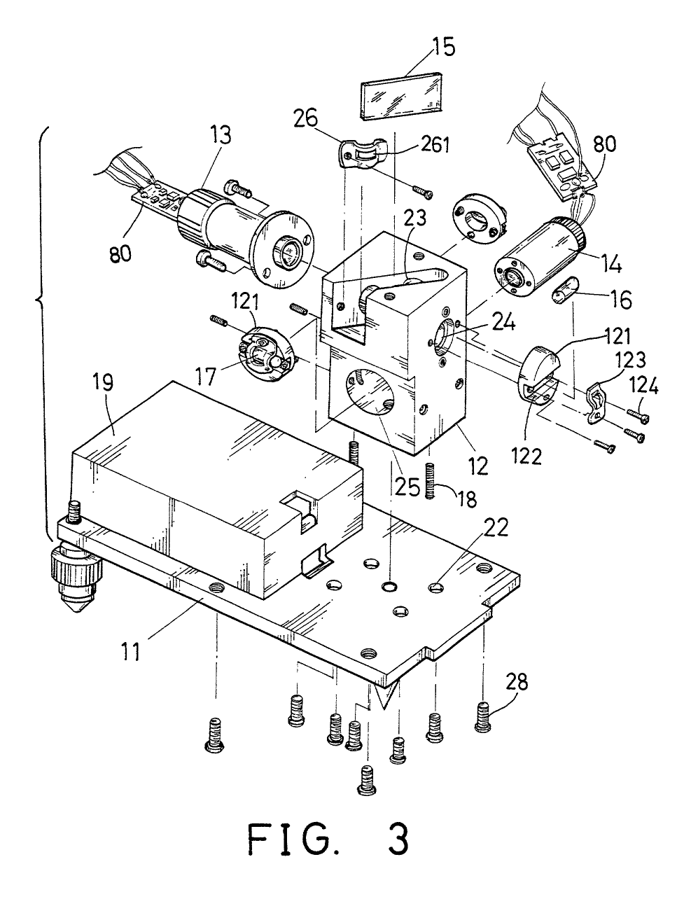

### DETAILED DESCRIPTION OF THE PREFERRED EMBODIMENT

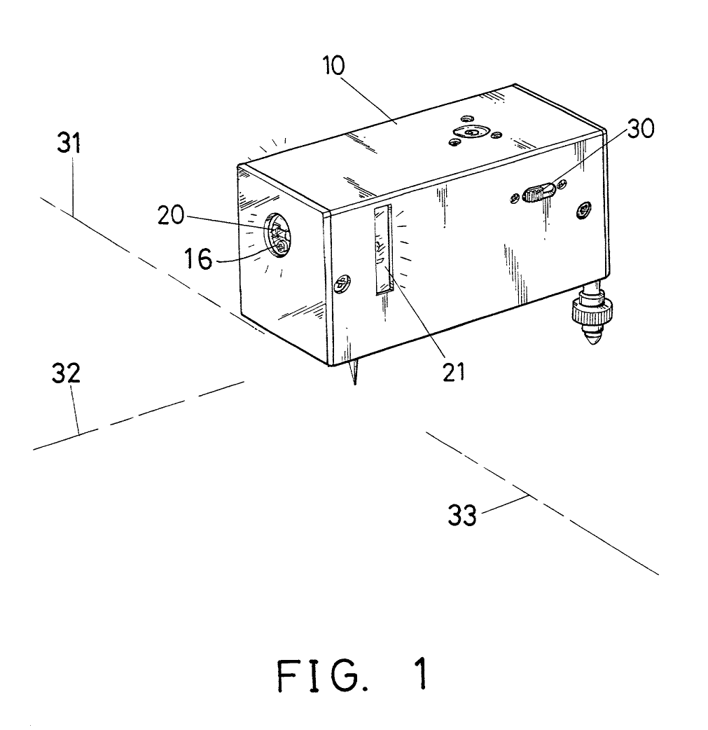

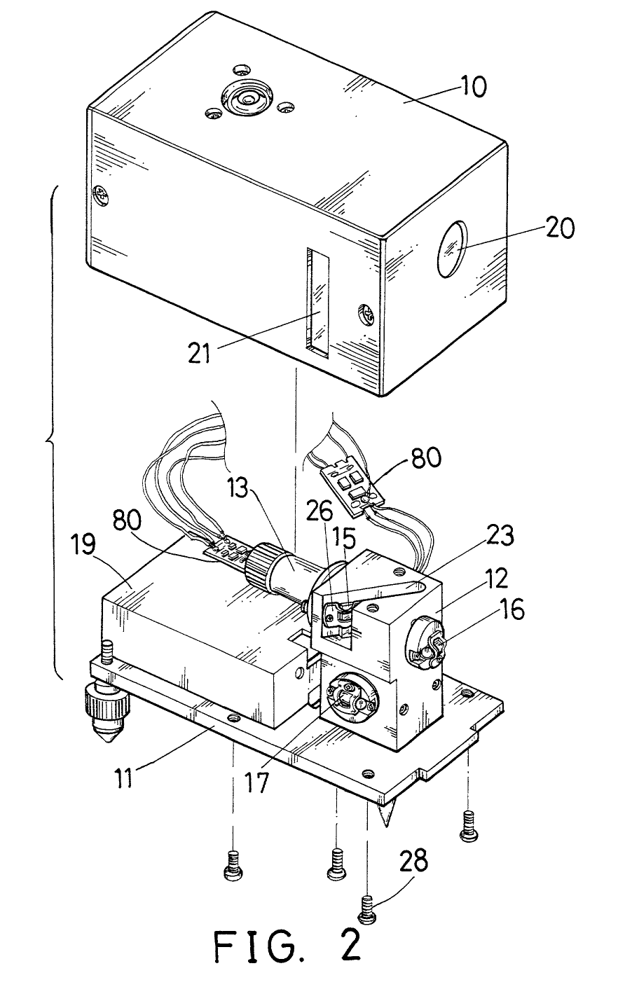

Referring to the drawings, and initially to FIGS. 1 and 2, a light or laser indicator in accordance with the present invention comprises a cover 10, a base 11 attached or secured to the bottom of the cover 10, with fasteners 28 or the like, for supporting the housing 12 of the indicator. The base 11 includes one or more holes 22 formed therein for receiving fasteners 18 which may secure the housing 12 to the base 11. The housing 12 includes an orifice 24 and an aperture 25 formed therein and spaced from each other and perpendicular to each other. The orifice 24 of the housing 12 is extended forwardly and rearwardly along the longitudinal direction of the housing 12, and the aperture 25 is extended sidewise along the lateral direction of the housing 12 and perpendicular to the aperture 25 of the housing 12. A slot 23 is formed in the housing 12 and intersecting or communicating with the orifice 24 of the housing 12 and includes a 45° included angle with the orifice 24 of the housing 12. The cover 10 includes a front portion having an opening or a window 20 formed or provided therein, and includes two opposite sides each having another opening or window 21 formed or provided therein.

Two electrical circuit connecting radiation sources 13, 14 are received in the orifice 24 and the aperture 25 of the housing 12 respectively and each is coupled to a circuit board 80 or the like for generating a light or radiation beam 31, 32. One or more batteries or the other power supply devices 19 may be disposed on the base 11 or secured to the cover 10 and are coupled to the circuit boards 80 and/or the radiation sources 13, 14 for energizing the radiation sources 13, 14. Two caps 121 are secured to the housing 12 and disposed in front of the radiation sources 13, 14 for securing or retaining the radiation sources 13, 14 within the housing 12. The caps 121 each includes a cavity 122 formed therein for receiving a lens 16, 17, such as a wide-angle lens 16, 17. Two brackets 123 are secured to the caps 121 with fasteners 124 or the like for securing the lenses 16, 17 to the caps 121 respectively and for retaining the lenses 16, 17 in front of the radiation sources 13, 14 respectively, in order to magnify or diverge the light or radiation beams generated by the radiation sources 13, 14.

A semi-transparent mirror 15 is engaged in the slot 23 of the housing 12 and intersecting with the orifice 24 of the housing 12 and secured to the housing 12 with a bracket 26 or the like. The bracket 26 includes a hole 261 formed therein for allowing the light or radiation beam to be emitted through the bracket 26. The light or radiation beam 32 (FIG. 1) generated by the radiation source 13 may include a portion (32) emitted through the mirror 15 and emitted out of the cover 10 through the window 20 of the cover 10. The other portion (31) of the light or radiation beam 32 (FIG. 1) generated by the radiation source 13 may be reflected by the mirror 15 and may be emitted out of the cover 10 through the other window 21 of the cover 10. The light or radiation beam 33 generated by the radiation source 14 may be directly emitted out of the cover 10 through the other window 21 of the cover 10 opposite to that for the light or radiation beam 31.

In operation, the radiation sources 13, 14 are directed toward the directions opposite to each other for indicating two opposite points far spaced away from each other. The light or radiation beam 31, 32 transmitted through and reflected by the semi-transparent mirror 15 may be used to indicate a right angle. The light or radiation beam 32, 33 emitted by the radiation sources 13. 14 may be used to indicate another right angle. The light or radiation beam 31, 32, 33 emitted by the radiation sources 13. 14 and transmitted through and reflected by the semi-transparent mirror 15 may be used to indicate two right angles.

Accordingly, the light or laser indicator in accordance with the present invention includes one or more radiation sources and a semi-transparent mirror for indicating one or more right angles or for indicating two opposite points far spaced away from each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An indicator comprising:
a housing,
a first radiation source and a second radiation source supported in said housing and directed to two directions perpendicular to each other, and
means for energizing said first and said second radiation sources to generate two light beams and to indicate a right angle.

2. The indicator according to claim 1, wherein said housing includes an orifice and an aperture formed therein and spaced from each other and perpendicular to each other for receiving said first and said second radiation sources.

3. The indicator according to claim 2, wherein said housing includes two caps secured thereto to block said orifice and said aperture of said housing and to retain said said first and said second radiation sources in said housing.

4. The indicator according to claim 3, wherein said caps each includes a cavity formed therein, said housing further includes two lenses engaged in said cavities of said caps respectively, said light beams generated by said first and said second radiation sources are emitted through said lenses respectively.

5. The indicator according to claim 4, wherein said housing further includes two brackets secured to said caps and engaged with said lenses to secure said lenses to said caps respectively.

6. The indicator according to claim 1, wherein said housing includes an orifice formed therein for receiving said first radiation source, and includes a slot formed therein and intersecting and communicating with said orifice thereof, and a mirror engaged in said slot of said housing.

7. The indicator according to claim 6, wherein said mirror is a semi-transparent mirror, said light beam generated by said first radiation source includes a portion transmitted through said mirror and another portion reflected by said mirror.

8. The indicator according to claim 6, wherein said mirror is intersected with said light beam generated by said first radiation source with a 45° included angle, said light beams transmitted through said mirror and reflected by said mirror indicate another right angle.

9. The indicator according to claim 6, wherein said housing includes a bracket secured thereto and engaged with said mirror for securing said mirror to said housing.

10. The indicator according to claim 9, wherein said bracket includes a hole formed therein and aligned with said light beam generated by said first radiation source for allowing said light beam generated by said first radiation source to transmit through said hole of said bracket.

11. The indicator according to claim 1 further comprising a cover for receiving said housing, said cover including two windows aligned with said light beams generated by said first and said second radiation sources for allowing said light beams to transmit through and out of said cover.

12. An indicator comprising:
a housing including an orifice and a slot formed therein and communicating with and intersecting with each other for a 45° included angle,
a first radiation source received in said orifice of said housing,
means for energizing said first radiation source to generate a light beam,
a mirror engaged in said slot of said housing and intersected with said first radiation source for a 45° included angle, said mirror being a semi-transparent mirror, said light beam generated by said first radiation source including a portion transmitted through said mirror and another portion reflected by said mirror to indicate a right angle.

13. The indicator according to claim 12, wherein said housing includes an aperture formed therein and spaced from and perpendicular to said orifice thereof, said indicator further includes a second radiation source received in said aperture of said housing to generate a light beam transmitted to a direction opposite to said light beam reflected by said mirror.

14. The indicator according to claim 12 further comprising a cover for receiving said housing, said cover including two windows aligned with said light beams transmitted through said mirror and reflected by said mirror.
